(19) United States
(12) Patent Application Publication
(10) Pub. No.: US 2015/0281670 A1
(43) Pub. Date: Oct. 1, 2015

(54) Reproducing Apparatus And Reproducing Method

(71) Applicant: HITACHI MAXELL, LTD., Osaka (JP)

(72) Inventors: Minoru Hasegawa, Fujisawa (JP); Nobuaki Kabuto, Kunitachi (JP)

(73) Assignee: HITACHI MAXELL, LTD., Osaka (JP)

(21) Appl. No.: 14/642,290

(22) Filed: Mar. 9, 2015

Related U.S. Application Data
(63) Continuation of application No. 13/249,287, filed on Sep. 30, 2011, now abandoned.

(30) Foreign Application Priority Data
Oct. 1, 2010 (JP) 2010-223384

(51) Int. Cl. H04N 13/00; H04N 13/04

(52) U.S. Cl. CPC H04N 13/0055; H04N 13/0048; H04N 13/0409

(57) ABSTRACT

A reproducing apparatus for outputting content to an external display device, comprises a decode portion, which is configured to decode the content, and an output portion, which is configured to output the content, being decoded in the decode portion, to the external display device, wherein information relating to a limit of displaying a 3D vision is added to the content outputted from the output portion, where the content to be outputted therefrom is that, the 3D vision of which is to be limited.

This application relates to and claims priority from Japanese Patent Application No. 2010-223384 filed on Oct. 1, 2010, the entire disclosure of which is incorporated herein by reference.

### BACKGROUND OF THE INVENTION

The technical field of the present invention relates to transmitting/receiving of video signals.

In the following Patent Document 1 are disclosed the followings: “to provide a three-dimensional (3D) video receiving apparatus and a 3-D vision system, for enabling to lower down the cost of the 3D video receiving apparatus and to process the video information received, on a real-time basis, thereby producing the 3D vision” (see [0008] of the Patent Document 1) as a problem to be dissolved, and as the means for dissolving thereof, “that for producing the 3D vision, upon basis of the video information, which is transmitted from said transmitting apparatus, comprising a receiving means for receiving a signal, onto which 2-dimensional (2D) video information received from said transmitting apparatus and additional information for producing a 3D vision are encoded, a decoding means for decoding said 2dimensional video information and said additional information from the signal received by this receiving means, and a producing means for producing the 3D vision applying parallax therein, with using said 2D video information and said additional information, which are decoded by said decoding means” (see [0009] of the Patent Document 1).

Also, in the following Non-Patent Document 1 is mentioned a method for transmitting a signal for displaying 3D vision according to HDMI (abbreviation of High-Definition Multimedia Interface, HDMI Licensing, a registered trade mark of LLC).

### PRIOR ART DOCUMENTS

### Patent Documents

[Patent Document 1] Japanese Patent Laying-Open No. 2000-78611 (2000).

### Patent Documents

[Non-Patent Document 1] “High-Definition Multimedia Interface Specification Version 1.4a Extraction of 3D Signaling Portion”, HDMI, LLC issue http://www.hdmi.org/manufacturer/specificatin.aspx

### BRIEF SUMMARY OF THE INVENTION

A producer of content of a 2D vision sometimes wishes to display that 2-D vision in the form of 3D vision, or wishes any kind of limination(s) therein. However, with such video displaying apparatus having a function of converting the vision from the 2D into the 3D, as is shown in the Patent Document 1, there is a problem that consideration cannot be made upon an intention of the content producer.

For dissolving such problem, according to the present invention, there are applied such structures as will be mentioned in the claims, later.

The present invention, including plural numbers of means for dissolving such problem as was mentioned above, comprises a step for decoding content, and a step for outputting the content decoded to an external display device, being characterized in that information relating to display of 3D vision is added to the content to be outputted, when the content to be outputted is that, display of the 3D vision of which is restricted.

According to the means mentioned above, it is possible to provide a 3D video of good quality to a viewer, reflecting the intention of the content producer thereupon.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an example of the structure of a video system;

FIG. 2 is a view for showing an example of description into a HDMI Vendor Specific InfoFrame;

FIG. 3 is a view for showing an example of describing information regulating 3D conversion into metadata;

FIG. 4 is a view for showing an example of description into the HDMI Vendor Specific InfoFrame;

FIG. 5 is a view for showing other example of describing the information regulating 3D conversion into the metadata;

FIG. 6 is a view for showing an example of operation flowchart of a 3D display apparatus having 3D conversion function;

FIG. 7 is also a view for showing an example of operation flowchart of a 3D display apparatus having 3D conversion function;

FIG. 8 is a view for showing an example of description into the HDMI Vendor Specific InfoFrame;

FIG. 9 is a block diagram for showing other example of the structure of the video system;

FIG. 10 is a view for showing other example of describing information regulating 3D conversion into metadata;

FIG. 11 is a view for showing an example of operation flowchart of the 3D display apparatus having 3D conversion function;

FIG. 12 is a block diagram for showing further other example of the structure of the video system;

FIG. 13 is a view for showing an example of description into the HDMI Vendor Specific InfoFrame;

FIG. 14 is a view for showing further other example of describing the information regulating 3D conversion into the metadata; and

FIG. 15 is a block diagram for showing further other example of the structure of the video system.

### DETAILED DESCRIPTION OF THE PREFERRED EMBODIMENTS

Hereinafter, explanation will be made on embodiments, according to the present invention. In the embodiments, which will be given blow, “3D vision” means a vision, through which an observer can sense an object in 3D, like existing in the space same to that of her/his own, by presenting an image having parallax between the left and the right eyes. Also, for example, a 3D display device means a display device, which enables display of the 3D vision. And, for example, 3D content means a content containing a video signal for enabling display of the 3D vision through processing within the 3D display device.

As a method for displaying the 3D vision by on the 3D display device are already known various ones; i.e., an anaglyph method, a polarized light display method, a frame/sequential method, a parallax barrier method, a lenticular lens method, a micro-lens array method, a light ray reproducing method, etc.

The anaglyph method is a method, in which images, each being photographed from a different angle on the left or the right, are reproduced by superimposing the lights of red and blue respectively, to be seen through a pair of glasses attached with color filters of red and blue on the left and the right (hereinafter, may be also called “anaglyph glasses”).

The polarized light display method is a method, in which images on the left and the right are superimposed to be projected, while linearly polarizing them perpendicular to each other, and this is separated by a pair of glasses attached with polarization filters (hereinafter, may be also called “polarization glasses”).

The frame-sequential method is a method, in which the images photographed from different angles on the left and the right are reproduced, alternately, to be seen thorough a pair of glasses attached with liquid crystal shutters for shutting off the fields of vision on the left and the right, alternately (hereinafter, may be also called “shutter glasses”).

The parallax barrier method is a method of superimposing a vertical stripe-like barrier, being called a “parallax barrier”, on a display, and thereby showing a right-eye vision for the right eye and a left-eye vision for the left eye, wherein there is no reason for a user to wear a special pair of glasses, etc. The parallax method can be classified, further, into a two (2) angle (or visual point) method, being relatively narrow in the position for viewing, and a multi-angle method, being relatively wide in the position for viewing, etc.

The lenticular lens method is a method of putting a lenticular lens is on a display, thereby to show the right-eye vision for the right eye and the left-eye vision for the left eye, respectively, wherein there is no reason for a user to wear a special pair of glasses, etc. This lenticular lens method can be also classified, further, into the two (2) angle (or visual point) method, being relatively narrow in the position for viewing, and the multi-angle method, being relatively wide in the position for viewing, etc.

The micro-lens array method is a method of piling up a micro lens array on a display, thereby showing the right-eye vision for the right eye and the left-eye vision for the left eye, respectively, wherein there is no reason for a user to wear a special pair of glasses, etc. This micro lens array method is the multi-angle method, being relatively wide, vertically and horizontally, in the position for viewing.

The light ray reproduction method is a method of reproducing wave surface or wave front of the light ray, thereby presenting a parallax image to an observer, wherein there is no reason for a user to wear a special pair of glasses, etc. And also, the position for viewing is relatively wide.

However, the methods for displaying the 3D vision mentioned above are only for showing an example; and it is also possible to apply a method(s) other than those. Also, tools and devices necessary for viewing the 3D vision, such as, the anaglyph glasses, the polarization glasses, the shutter glasses, etc., are called, “3D glasses, a 3D viewing device or 3D view assistance equipment, collectively.

### EMBODIMENT 1

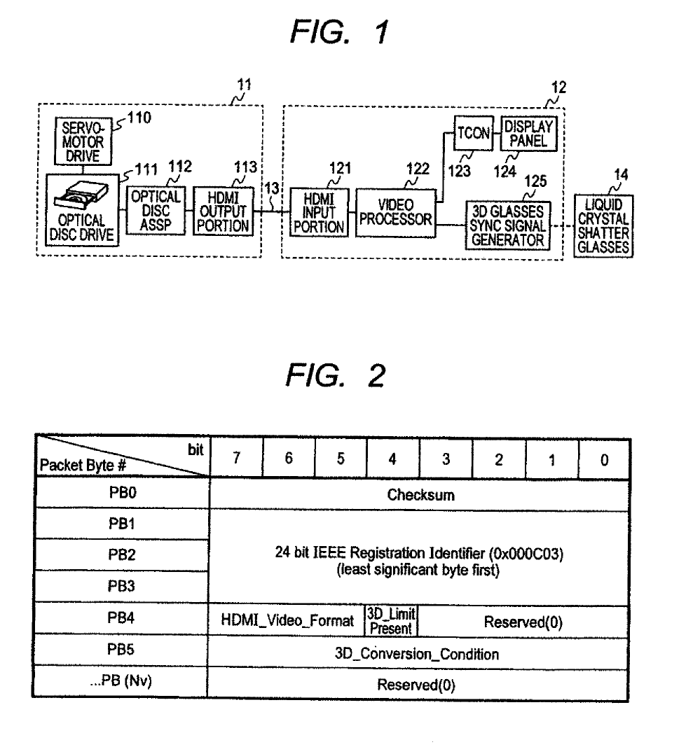

FIG. 1 shows an example of the structure of equipment according to the present embodiment. A video signal reproducing apparatus 11 is connected via a 3D display device 12 and a HDMI cable 13.

Within the video signal reproducing apparatus 11, a servo motor drive 111 drives an optical disc drive 112 (may be also called “recording/reproducing portion”), and after treating a signal read out with a process thereon, such as, decoding etc., within an optical disc ASSP (Application Specific Standard Product: a standard product for a specific purpose), a video signal is transmitted from a HDMI output portion to the 3D display device 12, through the HDMI cable 13.

The 3D display device 12 receives the video signal at a HDMI input terminal portion 121, and after being executed with video processing within a video processor 122, the 3D vision is displayed on a display panel 124 passing through TCON (e.g., a timing controller) 123. Also, a synchronous signal (hereinafter, simply “sync” signal) for driving shutter glasses is transmitted from the video processor 122 to a 3D glasses sync signal generator 125, and it is transmitted from the 3D glasses sync signal generator 125 to a pair of shutter glasses 126 through wireless communication with using infrared or radio waves, etc. Although explanation will be given on an example of the 3D display device adopting the frame/sequential method in the present embodiment, however, the present invention should not be limited to this; but it is also applicable to 3D display devices adopting other method therein.

Next, explanation will be made on 3D view limit information. This 3D view limit information is information for indicating a condition, in case if there is any condition (for example, allowing display of the 3D vision only when a condition is satisfied, etc.), in relation to display of the 3D vision on the 3D display device. The 3D view limit information may be recorded on an optical disc medium, or may be defined for classification, such as, a predetermined optical disc medium or a video signal reproducing device, accompanying with the copyright protection. A video signal reproducing apparatus, such as, a BD player, etc., provides an output attaching 3D view limit information metadata of the content thereto, upon basis of those 3D view limit information.

In case where the video signal reproducing apparatus has a tuner for receiving broadcasts, such as, a set-top box, etc., it may be so constructed that an output is provided, attaching 3D view limit information metadata of the content, which is received by the tuner, to the video signal decoded, upon basis of those 3D view limit information included in the broadcasted radio wave.

FIG. 2 is a view for showing the data structure of the HDMI Vendor Specific InfoFrame, in which the information relating to 3D video format when transmitting the HDMI. An address number of a unit of Byte is presented in the vertical line and the structure of a bit unit for each Byte in the horizontal line. First of all, HDMI_Video_Format of an address number PB4 of the HDMI Vendor Specific InfoFrame indicates that it is the video format being defined by the HDMI itself, independently, while “000” means that it is a common 2D video signal, “001” that it is a 2D video signal of 4k2k, and “010” that it is a 3D video signal, respectively. Further, the 2D video signal of 4k2k is a video signal, which has about two (2) times number of pixels of a full HD, 1,920×1,080 pixels, in the pixel number for each frame (in more details, 4,096×2,160 pixels).

1 bit of bit 4 of the address number PB4, which is defined as a reservation area or region (Reserved (0)) according to the HDMI, is defined as “3D_Limit_Present” in FIG. 2, for indicating presence of the 3D view limit information in relation to conversion from the 2D video into the 3D video, i.e., the 3D conversion. If this 3D Limit Present is “0”, it means that there is no 3D view limit information, on the other hand if it is “1”, it means that the 3D view limit information is described, separately.

In FIG. 2 assuming a common 2D video transmission, in general, the 3D_Limit_Present is set to “000”. In this case, since those after PB5 are Reserved (0), the PB5 at the beginning of this reserved region is assigned to a region for describing the details of the 3D view limit information, i.e., “3D_Conversion_Condition”.

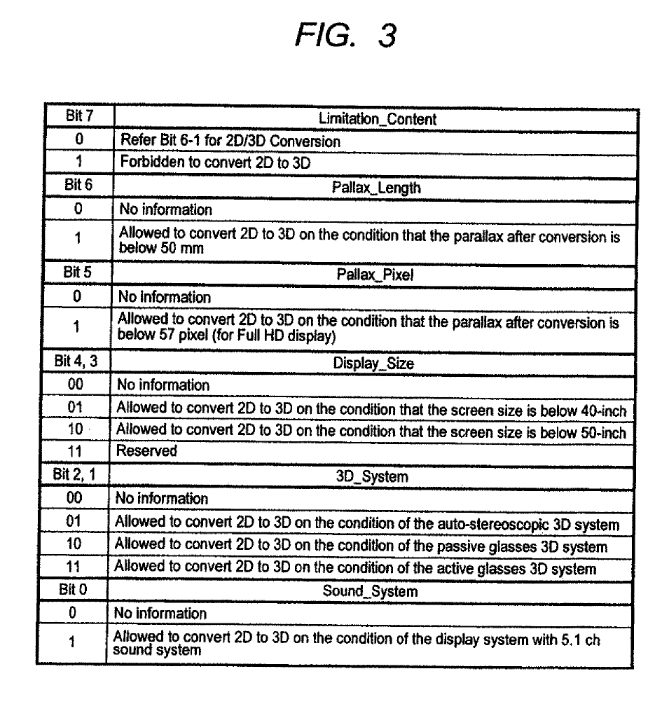

FIG. 3 shows an example of the details of the 3D view limit information shown in the 3D Conversion Condition. There can be listed up the following cases; i.e., “3D conversion is inhibited” (Bit 7), “3D conversion is allowed under the condition of setting an upper limit of an amount of parallax between the both eyes at 50 mm” (Bit 6), “3D conversion is allowed under the condition of setting the upper limit of an amount of parallax between the both eyes at 57 pixels in the case of Full HD resolution” (Bit 5), “3D conversion is allowed if it is a display device, being equal to or less than a predetermined size” (Bit 4 or 3), “3D conversion is allowed only if it is a 3D display device of a shutter glass method” (Bit 2 or 1), and “3D conversion is allowed only if it is a 3D display device having a 5.1 ch audio/video system” (Bit 0), however, it is also possible to set a condition combining plural numbers of those. However, the specific numerical values of the upper limits of the amount of parallax between the both eyes, etc., are shown, as an example only, but the present invention should not be restricted to those values.

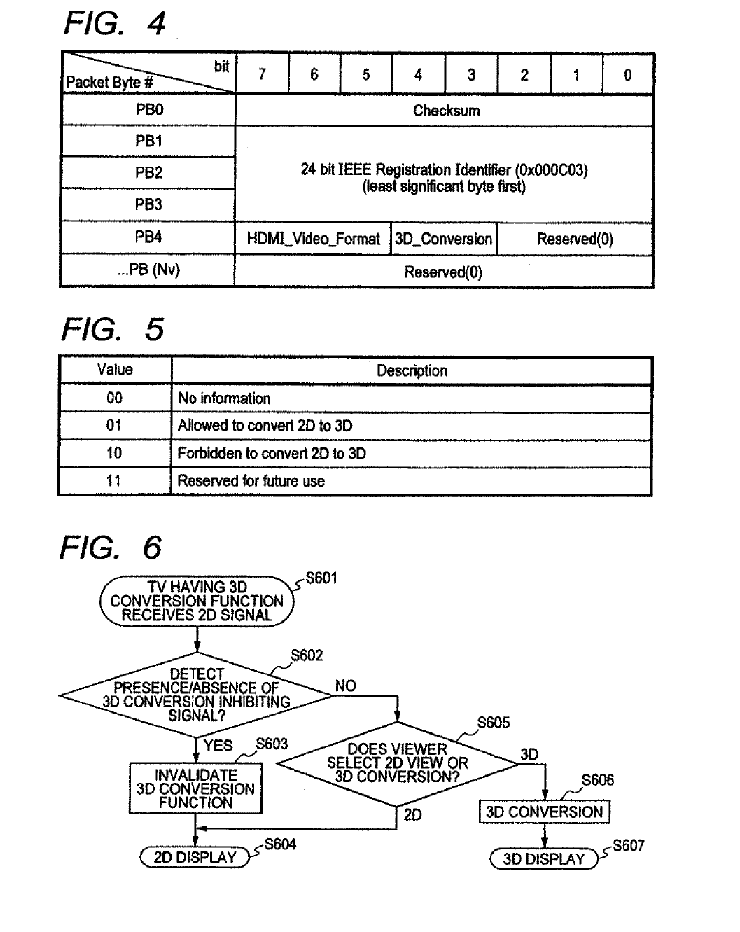

Also, in case where it is enough to set only the “3D conversion is inhibited”, the HDMI Vendor Specific InfoFrame may adopt a manner of describing an abbreviation thereof, as is shown in FIG. 4 in the place of FIG. 2. Or, “3D_Conversion” may be set by 2 bits of the bits 4 and 3 of the address number PB 4.FIG. 5 shows an example of this 3D_Conversion. “no information relating to 3D conversion”, “allow 3D conversion” and “3D conversion is inhibited” are set up therein.

In this manner, the 2D signal attached with the information relating to the 3D conversion is processed within the video processor 122 in the 3D display device 12 shown in FIG. 1. FIG. 6 shows an example of a flowchart of operations processed within the video processor 122 when the 3D display device having the 3D conversion function receives the 2D signal.

First of all, the 3D display device having the 3D conversion function receives the 2D signal (S601). By analyzing the metadata, which is described in the HDMI Vendor Specific InfoFrame of this 2D signal, detection is made of presence/absence of a 3D conversion inhibiting signal (S602). As a result if the 3D conversion is not inhibited, a viewer can select to view it in the 2D or to view the video after the 3D conversion thereof, through an operation on a remote controller, etc. (S605), and can view the video that she/he selected (S604, S606 and S607). When the 3D conversion inhibiting signal is detected, the 3D display device invalidates the 3D conversion function, i.e., bringing it into such condition that it cannot operate the 3D conversion (S603). For that reason, for the viewer, it is only possible to select viewing of the 2D video (S604).

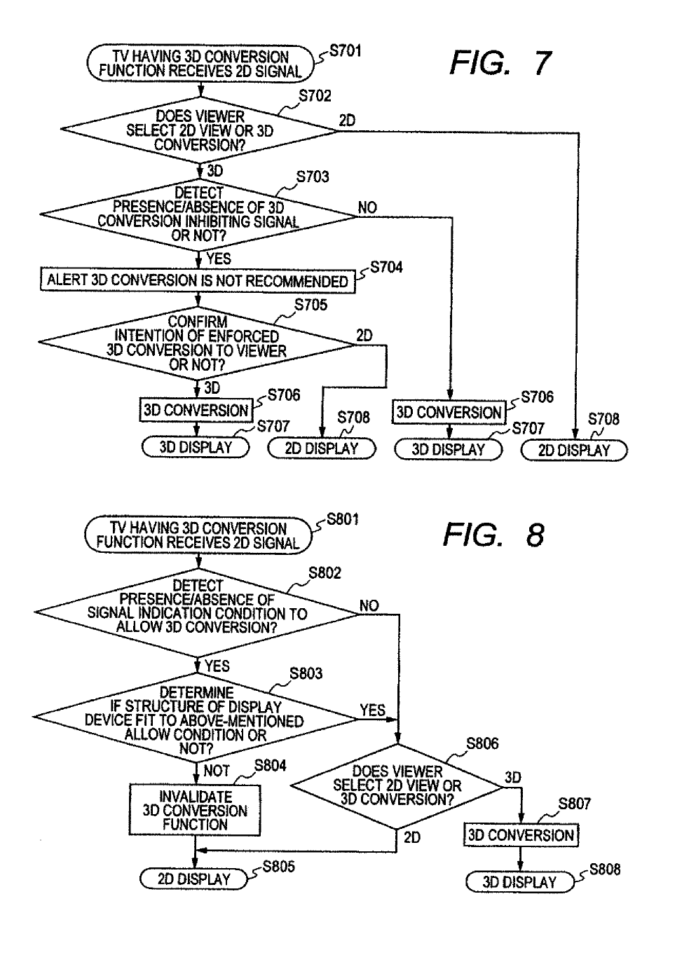

FIG. 7 shows an example of a flowchart of operations in case of a 3D display device, which can enforce the 3D conversion at viewer's will even if receiving the 3D conversion inhibiting signal. In this case, since the 3D conversion function cannot be invalidated, the viewer selects if she/he wishes to view 2D or 3D before the 3D conversion inhibiting signal is detected.

When the 3D display device having the 3D conversion function receives the 2D signal (S701), the user selects to view the 2D video or to view the 3D video (S702). In case where the user selects to view the 2D video, display of the 2D video is executed (S708), without conducting the conversion into 3D.

If the user selects to view the 3D vision in S702, detection is made on presence/absence of the 3D conversion inhibiting signal (S703). If there is no 3D conversion inhibiting signal, conversion into the 3D video is executed (S706), and the viewer can view the video, which is converted into the 3D vision (S707).

If the 3D conversion inhibiting signal is detected in S703, a display is made on a display screen, such as, “although 3D is not recommended, should 3D display be done or not?” or the like, through an OSD (On Screen Display) and so on (S704). Thereafter, confirmation is made on if the 3D conversion should be enforced or not, to the viewer (S705), and thereby determining the presence/absence of the conversion into 3D vision through the selection made by the viewer.

FIG. 8 shows an example of a flowchart of operations, in particular, when the 3D display device having the 3D conversion function receives a conditional 3D allowing 2D signal. First of all, the 3D display device having the 3D conversion function receives the 2D signal (S801). Analyzing the metadata of this 2D signal, detection is made on presence/absence of the “conditional 3D allowing 2D signal” (S802).

As a result of this, if “conditional 3D conversion allowance” is not made up, the viewer can select to view in 2D or to view the video after the 3D conversion (8806), and if viewing of the 2D vision is selected, the 2D vision is displayed without executing the conversion into the 3D vision (S805), while if viewing of the 3D vision is selected, conversion is executed into the 3D vision (S807) and the 3D vision is displayed (S808).

In case where the “conditional 3D conversion allowance” signal is detected, the 3D display device determines if the structure of the display device fits with the condition, or has a capacity for executing the 3D conversion under the condition designated (S803). If it does not fit to the allow condition, the 3D conversion function is invalidated (S804), and the 2D vision is displayed (S805). If it fits to the condition for the allowance, the viewer can select to view the 2D vision or to view the vision after the 3D conversion, at her/his option (S806).

With such structure as was mentioned, it is possible to execute the restriction of the 3D display in accordance with the 3D view limit information, which is superimposed on the video signal.

### EMBODIMENT 2

In the embodiment 1, it was assumed that the details of the 3D view limit information be described in “3D_Conversion_Condition” in FIG. 2. However, there is a possibility that it is difficult to regulate all of the detailed and complex conditions, to be assigned with signals thereto.

Then, it is also possible to inquire or refer the information in relation with the detailed 3D view limit to external equipment, such as, a server on a network, etc., for example, while describing only the information corresponding to an identification number in the HDMI Vendor Specific InfoFrame. And, by obtaining the limit information through connection with the server, there can be listed up the following advantages; i.e., a content holder can ease or strengthen a viewing condition after seeing a trend or tendency of the market, or can make a timely response, such as, a movement of a campaign, etc.

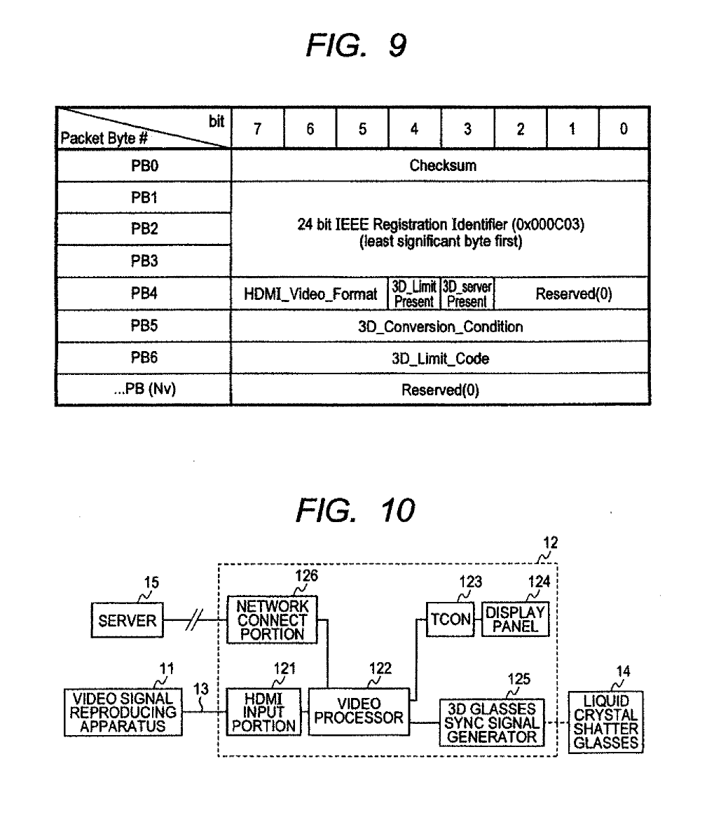

FIG. 9 shows an example of the data structure of the HDMI Vendor Specific InfoFrame in this case. Bit 3 of an address number PB4 of the HDMI Vendor Specific InfoFrame is defined as “3D_Server_Present”, thereby indicating if the detailed limit information is registered or not in the server.

If here is “0”, there is no necessity of inquiring the information to the server, and the display device follows the information of the “3D_Conversion_Condition”. If “1”, it means that the limit information is on the server. In this instance, since there is a possibility of being untenable to inquire the information to the server, such as, where the display device is not connected with the network, etc., for example, and in such case, the display device follows the information of the “3D_Conversion_Condition”.

Accordingly, even if the “3D Server Present” is “1”, it is preferable that the limit information is described in the “3D Conversion Condition”. The information described in the server has priority to the information of “3D Conversion Condition” only the case where the inquiry to the server is succeeded.

In case where the “3D_Server_Present” is “1”, further an identification number of the limit information is described in a region, which is defined as “3D Limit Code” in the address number PB6 of the HDMI Vendor Specific InfoFrame. The display equipment, acknowledging the limit information upon basis of this identification number, executes the processing in accordance with that limitation thereof.

FIG. 10 shows an example of the structure of the equipment in case of inquiring the limit information to the external equipment. The 3D display device 12 is connected with an external server, from a network connecting portion 126 through a network circuit. When the video processor determines that the video signal is a signal meaning “inquire the limit information to the external server” therein, it inquires the limit information to the external server, and executes the processing in accordance with that limitation thereof.

Also, the limit information is reserved in a memory provided within the display device, and the external server may overwrite the information in the memory within the display device when that limit information is renewed. In that case, since the video processor can inquire the limit information to the memory within the display device, it is possible to speed the processing therein.

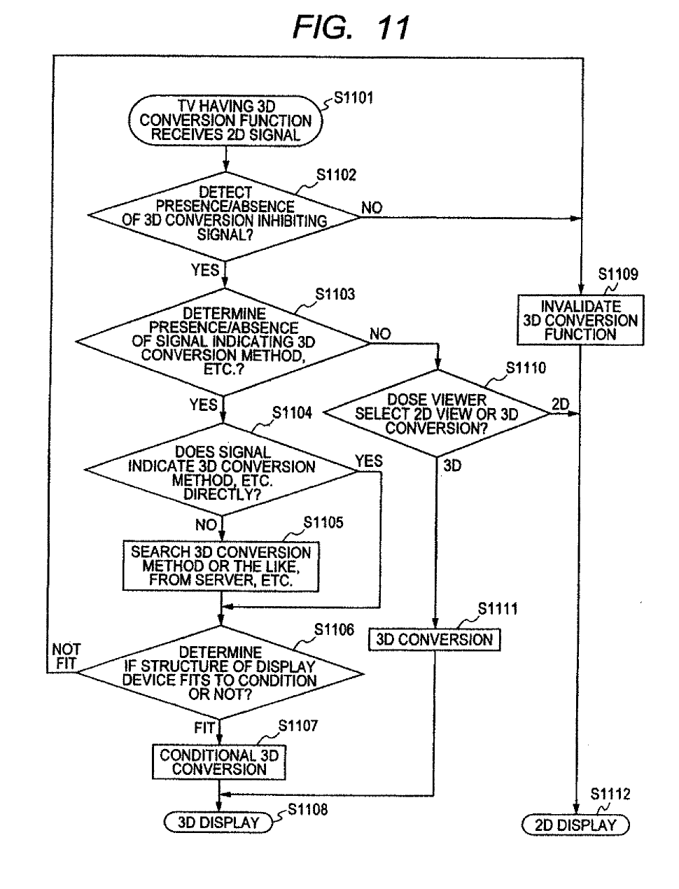

FIG. 11 shows an example of a flowchart of operations when the 3D display device having the 3D conversion function receives a signal having a necessity of inquiring the condition to the external equipment, i.e., the 2D signal of the conditional 3D allowance.

First of all, the 3D display device having the 3D conversion function receives the 2D signal (S1101), and detects the 3D conversion inhibiting signal (S1102). When the 3D conversion inhibiting signal is detected, the function for converting into the 3D vision is invalidated (S1109), and then display of the 2D vision is conducted (S1112).

In case where no such 3D conversion inhibiting signal is detected, the “conditional 3D conversion allowance” signal (S1103).

As a result of that, if the “conditional 3D conversion allowance” signal is not detected, the display of 2D vision is conducted (S1112) responding to selection by the viewer (S1110), or conversion into the 3D vision (S1111) and the display of 3D vision (S1108) are conducted.

When detecting the “conditional 3D conversion allowance” signal, the 3D display device determines if the “condition” is directly described or not, in the signal (S1104). As a result thereof, if the “condition” is not described directly, then it execute an inquiry relating to the “condition” to the external equipment, such as, the server or the like (S1105).

Following to the above, determination is made on if the structure of the display device is fitted to the “condition” obtained, or not (S1106). If not fitting to the condition for the allowance, the 3D conversion function is invalidated (S1109), and thereby conducting the display of 2D vision (S1112). If fitting to the allow condition, conversion into the 3D vision is conducted (S1107), and then the 3D vision is displayed (S1108) However, the above may be so constructed that the 2D vision can be displayed through selection by the user even if fitting to the condition in S1106.

With such structure, it is possible to set up the complex 3D view limit information with a small number of bits, or to alter or add the 3D view limit information timely.

### EMBODIMENT 3

An assumption was made that the information relating to the 3D conversion is described in the video signal as the metadata, in the embodiments 1 and 2. However, there is a possibility that the metadata may be modified or eliminated by the processing during the time when it passes through intermediate equipments, such as, a set-top box, etc. For the purpose of avoiding such things, the information relating to the 3D conversion may be described in the form other than the metadata.

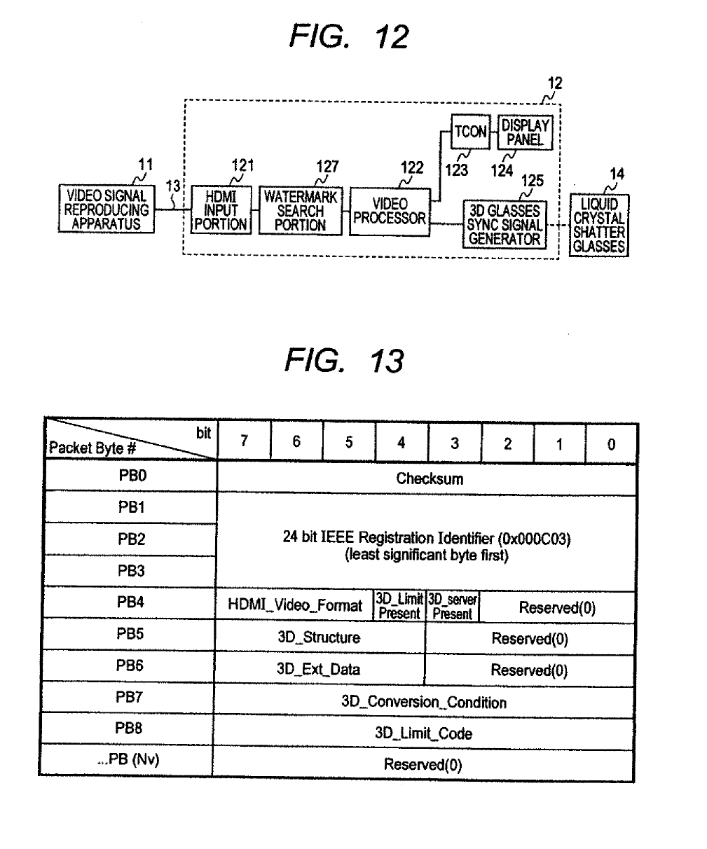

As an example, the information is described in a color signal within the video signal, as a watermark, etc. FIG. 12 shows an example of the structure of equipment in that case. The video signal transmitted from the video signal reproducing apparatus 11 is received at the HDMI input terminal 121 of the 3D display device 12. Among the color signals of the video signal, which is transmitted from the HDMI input terminal 121 into a watermark search portion 127, detection of the watermark is executed. A result of that detection and the video signal, as well, are transmitted to the video processor 122, and the video processor 122 executes the processing upon basis of the result of detection received.

With such structure, it is possible to describe the 3D view limit information within the color signal of the video signal but not in the form of the metadata, and thereby achieving restriction of display of the 3D vision without using the metadata therein.

### EMBODIMENT 4

Although an assumption was made that the limit or restriction is put on the 3D conversion from the 2D video signal, in the embodiments 1 to 3; however, there is a case where the restriction is put on when the 3D video signal is displayed. As an example thereof, the followings can be listed up; such as “inhibit the 2D view, in case where a contents producer wishes the contents to be viewed in 3D, necessarily”, “a vision for the left eye is displayed when conducting the 2D display”, “the 3D conversion is allowed upon setting an upper limit of amount of parallax between the both eyes at xx mm”, “the 3D conversion is allowed upon setting an upper limit of amount of parallax between the both eyes at xx pixels in case of the Full HD resolution”, “the 3D conversion is allowed if the display device has a size, being equal to or smaller than a predetermined size”, “the 3D conversion is allowed only for the 3D display device of the naked eye method” and “the 3D conversion is allowed only for the 3D display device having the 5.1 ch sound system”.

FIG. 13 shows an example of the HDMI Vendor Specific InfoFrame in this case. In “HDMI_Video_Format” is described “010” indicative of being the 3D signal. Further, in “3D_Limit_Present” is described “1” indication “having the conversion limit”. In the embodiment 1, the former is “000” and the latter “1”; however, in case where the former is “010” and the latter “1”, as is in the present embodiment, the definition of “3D Conversion Condition” following thereto differs from that shown in FIG. 3.

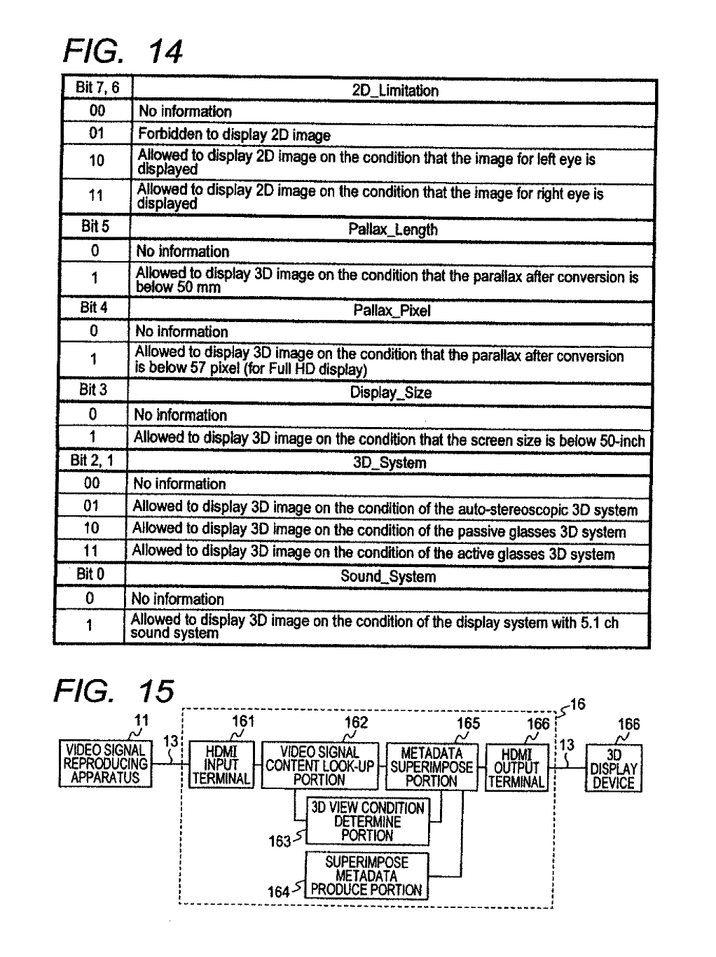

FIG. 14 is a view for showing an example of the “3D_Conversion_Condition” of adding the limit when displaying the 3D content, as in the present embodiment, i.e., where the “HDMI_Video_Format” is “010” and the “3D_Limit_Present” is “1”. There is described the limit when displaying the 3D content in 2D or when displaying the 3D content in 3D therein.

With such structure, it is possible to conduct displaying in accordance with the 3D view limit information when displaying the 3D video signal.

### EMBODIMENT 5

FIG. 15 shows an example of the structure of a signal generator for producing a video signal, to which a signal regulating 2D or 3D is added. In a middle between the video signal reproducing apparatus 11 and the 3D display device 12 is disposed a video signal generating device 16.

This signal generating device 16 receives the video signal transmitted from the video signal reproducing apparatus 11 at a HDMI input terminal 161 thereof. A video signal content look-up portion 162 search or looks up the content of a color signal of the video signal, which received therein. A result of this look-up is received by a 3D view condition determine portion 163, wherein a necessity for regulating the 3D conversion upon basis of the data relating to the 3D view conditions; such as, “an amount of parallax between both eyes becomes excessive when executing the 3D conversion”, “it is not preferable to view in 3D because an amount of parallax between both eyes is changed abruptly in a short time-period” and “it is not preferable to view in 3D because scene changes occur frequently”, for example.

A result of that determination is received by a metadata superimpose portion 165, wherein a video signal superimposing metadata onto the 2D signal is produced. Also, in case where there is a necessity of regulating the 2D display and/or the 3D display upon basis of an intention of the content producer, etc., regulation information is produced in a superimpose metadata produce portion 164, through a keyboard input, etc., and the regulation information is received by a metadata superimpose portion 165, wherein a video signal superimposing the metadata onto the 2D is produced. The 2D signal attached with the metadata for regulating the 3D conversion is transmitted to the 3D display device 12, wherein processing in accordance with the 3D conversion regulation information described in the metadata is executed.

With such structure, it is possible to produce/transmit the video signal superimposing the 3D view limit information, which is not described in an original video signal.

However, in each of the embodiments mentioned above, the conversion process into the 3D vision may be conducted in the video processor 122, or other conversion process portion may be provided separating from the video processor.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1-6. (canceled)

7. A reproducing apparatus for outputting a 3D video signal to a display device, comprising:
an output portion, which is configured to output the 3D video signal to the display device, wherein the output portion append 2D_Limitation information to the 3D video signal and
the 2D_Limitation information indicates which image for left or right eye is selected to display as 2D image.

8. The reproducing apparatus, as is described in the claim 7, further comprising:
a decoding portion, which is configured to decode a content to the 3D video signal and
a recording/reproducing portion for reproducing the content from a recording medium,
wherein the 2D_Limitation information is provided from the recording medium.

9. The reproducing apparatus, as is described in the claim 7, further comprising:
a decoding portion, which is configured to decode a content to the 3D video signal and
a receiving portion, which is configured to receive the content on a broadcasted radio wave, wherein the 2D_Limitation information is received by the receiving portion.

10. A display device to display a 3D video signal with 2D_Limitation information from a reproducing apparatus,
wherein when the display device is set to display 2D image, the 2D image is selected from the 3D image based on the 2D_Limitation information which image for left or right eye is selected to display as 2D image.

11. A reproducing method for outputting a 3D video signal to a display device, comprising the following step of:
a step of decoding a content to the 3D video signal; and
a step of outputting the 3D video signal to the display device, wherein
2D_Limitation information which image for left or right eye is selected to display as 2D image, is appended to the 3D video information, where the 2D_Limit information is appended to the content.
